(19) United States
(12) Patent Application Publication
(10) Pub. No.: US 2012/0306264 A1
(43) Pub. Date: Dec. 6, 2012

(54) SWITCH LOAD SHEDDING DEVICE FOR A DISCONNECT SWITCH

(75) Inventors: Thomas Komma, Ottobrunn (DE); Kai Kriegel, München (DE); Jürgen Rackles, Puchheim (DE)

(73) Assignee: Siemens Aktiengesellschaft, Munich (DE)

(21) Appl. No.: 13/578,153

(22) PCT Filed: Feb. 1, 2011
(86) PCT No.: PCT/EP2011/051387

§ 371 Date: Aug. 9, 2012

(30) Foreign Application Priority Data
Feb. 10, 2010 (DE) 10 2010 007 452.7

(51) Int. Cl. H01H 35/00; B60L 1/00

(52) U.S. Cl. 307/9.1; 307/113

(57) ABSTRACT

A switch load shedding device for a disconnect switch may be used in electric vehicles. The disconnect switch must perform a galvanic disconnect between the battery and the intermediate circuit. To this end, at least one semiconductor switch is used. The current to be switched off is conducted via the semiconductor switch for disconnecting the electric connection. The disconnect switch is previously or subsequently switched off under reduced voltage buildup.

### CROSS REFERENCE TO RELATED APPLICATIONS

This application is based on and hereby claims priority to International Application No. PCT/EP2011/051387 filed on Feb. 1, 2011 and German Application No. 10 2010 007 452.7 filed on Feb. 10, 2010, the contents of which are hereby incorporated by reference.

### BACKGROUND

The invention relates to a switch load-shedding device of a disconnect switch for galvanically isolating an electrical connection, and an associated method for load shedding.

Traction drives for electrically operated vehicles usually have a battery and a converter for operating the electric motor or motors. The battery provides the electrical power and the converter converts the direct voltage of the battery into a suitable alternating voltage or three-phase current. For safety reasons, a facility for galvanically isolating the battery from the intermediate circuit of the converter is compulsorily specified. This isolation must be possible at all times.

Battery disconnect switches (battery contactors) which are capable of switching off the maximum battery current are therefore used in electrically operated vehicles. The possible currents which occur are comparatively high, as there is no zero crossover with the direct current supplied by the battery. The battery disconnect switch therefore turns out to be comparatively bulky and is expensive.

### SUMMARY

One possible object is to avoid or minimize the disadvantages mentioned above. In particular, a way is to be provided to make the battery disconnect switch smaller.

The inventors propose a switch load-shedding device of a disconnect switch for galvanically isolating an electrical connection has at least one semiconductor switch. Furthermore, for the isolation of the electrical connection, it is designed to allow the current which is to be switched off to flow via the semiconductor switch, thus effecting a reduced voltage buildup across the disconnect switch when it is being switched off.

In doing so, there are different design possibilities or procedures with which the current which is to be switched off flows via the semiconductor switch before or after the disconnect switch is switched off. Expediently, the semiconductor switch is electrically connected to the disconnect switch.

Advantageously, this enables the disconnect switch to be switched off so that it remains either completely free from voltage and current, or at least one diversion path which reduces or prevents the formation of an arc is provided for the current. This reduces the demands on the disconnect switch. It must merely be able to guarantee galvanic isolation and to carry the rated current. As a result, it is possible to make the disconnect switch smaller.

Preferably, the current is switched off by the semiconductor switch in that the semiconductor switch is switched to a non-conducting state when the current to be switched off flows via the semiconductor switch. This can occur before the disconnect switch is switched off or after the disconnect switch is switched off.

The use of the device in an electrically operated vehicle is particularly advantageous. The disconnect switch corresponds to the battery disconnect switch which is necessarily present for galvanically isolating the battery from the intermediate circuit. The device is used to shed the load on the battery disconnect switch. Here in particular, a reduced size of the battery disconnect switch has a particularly positive effect due to the limited installation space. Furthermore, problems particularly occur here, as, in contrast with conventionally operated vehicles, significantly increased voltages, in particular those above 24 V, are used with electrically operated vehicles. Typical voltages can be greater than 400 V.

According to one embodiment, a series circuit comprising a mechanical load-shedding switch and the semiconductor switch is arranged in parallel with the disconnect switch. In doing so, it is expedient that first the mechanical switch then the semiconductor switch are switched to a conducting state and then the disconnect switch is switched to a non-conducting state in order to isolate the electrical connection. This ensures that the mechanical load-shedding switch is switched on without voltage loading and, when the disconnect switch is being switched off, the current can commutate to the semiconductor switch and the mechanical load-shedding switch.

Furthermore, it is expedient when the semiconductor switch is switched off, i.e. put into the non-conducting state, first after the disconnect switch has been switched off. Finally, expediently, the mechanical load-shedding switch is opened again.

According to a further embodiment, the current which is to be switched off already flows via the semiconductor switch before the disconnect switch has been switched off. The semiconductor switch is in particular arranged in series with the disconnect switch for this purpose. With this design, it is expedient that first the semiconductor switch is switched to a non-conducting state and then the disconnect switch is switched off in order to isolate the electrical connection.

Preferably an overvoltage protection device for the semiconductor switch is provided in parallel with the semiconductor switch. This serves to limit the voltage across the semiconductor switch and, for example, absorbs overvoltages which occur as a result of cable inductances when switching off the battery current.

If the disconnect switch is used for isolating a voltage source from a converter, for example, then it is advantageous when the device includes a pre-charging circuit. The pre-charging circuit has a series circuit which comprises a mechanical pre-charging switch and a pre-charging resistor to limit the current. It is arranged in parallel with the disconnect switch.

According to a particularly advantageous embodiment, the semiconductor switch undertakes the function of a current limit by pulsed switching on and off. As a result, as well as the function of switch load shedding, the semiconductor switch can also effectively undertake the function of a pre-charging circuit.

In certain fields of use, a second overvoltage protection device can be provided in series with the disconnect switch. In electric vehicles, this serves to protect the battery against overvoltages from the direction of the electric motor. These can occur in field-weakening mode, for example, if the converter fails.

According to a particularly advantageous improvement, in addition to the switch load shedding, the semiconductor switch also undertakes the function of the second overvoltage protection device. In doing so, it is expedient when, for example, a reverse blocking IGBT is used as the semiconductor switch. This has an adequate blocking capability in both directions.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a circuit with battery disconnect switch, parallel arranged load-shedding circuit and pre-charging circuit,

FIG. 2 shows a circuit with battery disconnect switch and parallel arranged load-shedding circuit,

FIG. 3 shows a circuit with battery disconnect switch, serially arranged load-shedding circuit and pre-charging circuit, wherein the semiconductor switch of the load-shedding circuit is protected against overvoltages,

FIG. 4 shows a circuit with battery disconnect switch, serially arranged load-shedding circuit and pre-charging circuit, wherein the semiconductor switch of the load-shedding circuit is protected against overvoltages by an RC circuit,

FIG. 5 shows a further circuit with battery disconnect switch and serially arranged load-shedding circuit,

FIG. 6 shows a circuit with battery disconnect switch and serially arranged semiconductor component which acts as a load-shedding circuit and battery protection switch.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

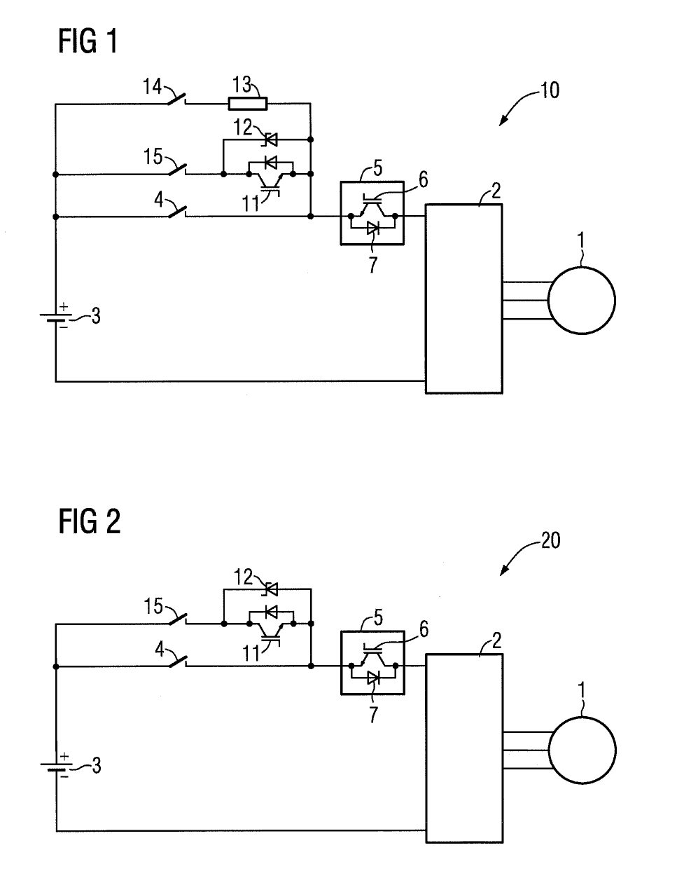

FIG. 1 shows highly schematically the design of a drive system 10 according to a first exemplary embodiment for an electrically operated vehicle. It is known that, instead of a conventional engine, a plurality of electric motors is often used in electrically operated vehicles in order, for example, to drive the wheels of the vehicle separately. In the figures, the electric motor 1 represents the one or more electric motors 1 which are used in the electrically operated vehicle. In the example shown, the electric motor 1 is a permanent-magnet-excited synchronous motor.

A converter 2 is provided to operate the synchronous motor 1. For itself, the converter 2 is constructed in a known manner and is connected on the output side to the electric motor 1 in a suitable manner. On the input side, the converter 2 is connected indirectly to a battery 3. The battery 3 supplies a direct voltage. A rectifier is therefore expediently not provided in the converter 2. This in turn means that typically the battery 3 is connected to the intermediate circuit of the converter 2 by intermediate components which are described below.

In an electrically operated vehicle, as a result of the comparatively high intermediate circuit voltages, it is specified that it must be possible to galvanically isolate the battery 3 from the intermediate circuit of the converter 2. For this purpose, a mechanical battery disconnect switch 4 is provided between the positive connection of the battery 3 and the intermediate circuit of the converter 2. The battery disconnect switch 4 is designed to be able to carry the rated current and to guarantee galvanic isolation in the open state.

The drive system 10 according to FIG. 1 has a pre-charging circuit in parallel with the battery disconnect switch 4. The pre-charging circuit includes a series circuit comprising a mechanical pre-charging switch 14 and a pre-charging resistor 13. The pre-charging circuit is used at the instant at which the battery disconnect switch 4 is switched on. At this point in time the discharged intermediate circuit capacitance acts like a short circuit. In order to limit the flowing current, the pre-charging circuit is therefore used first for switching on until the intermediate circuit is adequately pre-charged. Only then is the battery disconnect switch 4 closed and the mechanical pre-charging switch 14 opened once more.

Components to shed the load on the battery disconnect switch 4, which are likewise connected in parallel with the battery disconnect switch 4 and furthermore also in parallel with the pre-charging circuit, are provided in the circuit according to FIG. 1. These components include a series circuit comprising a mechanical load-shedding switch 15 and an IGBT 11. A protection circuit against overvoltages for the IGBT 11, which comprises a suppressor diode 12, is provided in parallel with the IGBT 11.

In the case of electrical drives with permanently excited synchronous machines, high voltages, which must be constrained by the battery 3, can occur if the converter 2 fails in field-weakening mode. An overvoltage protection module 5 is therefore provided between the battery disconnect switch 4 and the further components connected in parallel therewith and the converter 2. This is formed by an IGBT 6 and a diode 7 which is arranged in a blocking manner from the converter 2 to the battery 3.

The following switching operations are carried out if the battery current, possibly the maximum battery current, is to be switched off in the circuit according to FIG. 1. In doing so, it is assumed that the battery disconnect switch 4 is switched on, the mechanical load-shedding switch 15 and the semiconductor switch 11 are switched off, and the mechanical pre-charging switch 14 is likewise switched off. The current therefore flows via the battery disconnect switch 4. In order to switch off, the mechanical load-shedding switch 15 is first switched on. This does not yet effect any change on account of the switched-off semiconductor switch 11. In the next step, the semiconductor switch 11 is switched on. In the following step, the battery disconnect switch 4 is opened. As the current is now able to take the indirect path via the load-shedding circuit, the voltage across the battery disconnect switch 4 remains low. The switching-off operation of the battery disconnect switch 4 is therefore problem-free. In other words, with regard to its design, the battery disconnect switch 4 does not have to be designed to switch off the high maximum battery current.

In the next step, the semiconductor switch 11 is switched off. The intermediate circuit voltage therefore builds up across the semiconductor switch 11. In doing so, this can be further increased by the cable inductances, for example of the battery cable. In this example, any overvoltages are limited by the suppressor diode 12. The mechanical load-shedding switch 15 is subsequently switched off without current.

In the first exemplary embodiment given according to FIG. 1, although the battery disconnect switch 4 is thus not switched off without current, a low-resistance diversion path is offered for the current flow. Like the battery disconnect switch 4, the mechanical load-shedding switch 15 guarantees a galvanic isolation of battery 3 and the intermediate circuit of the converter 2 as well as ensuring that the current can only take the path via the semiconductor switch 11 for the switch-off operation. The mechanical load-shedding switch 15 itself is switched off without current after the semiconductor switch 11 has been switched off. The problematic switch-off operation is therefore shifted from the battery disconnect switch 4 to the semiconductor switch 11. Here, the switch-off operation is unproblematic. Advantageously, with the design according to FIG. 1, the semiconductor switch 11 is only in the current path for a short time.

With the design according to FIG. 1 and with the other exemplary embodiments, a control unit is provided in order to control the operations. In the first exemplary embodiment, this controls the mechanical pre-charging switch 14, the mechanical load-shedding switch 15 and the battery disconnect switch 4. It also controls the semiconductor switch 11. Furthermore, the control unit controls the IGBT 6 which is responsible for the overvoltage protection of the battery 3. For this, it is expedient when a continuous monitoring of the functional capability of the IGBT 6 is provided. This too is carried out by the control unit.

A second exemplary embodiment is described with reference to FIG. 2. Here, the second exemplary embodiment is constructed in a similar way to the first exemplary embodiment. Unlike the first exemplary embodiment, a pre-charging circuit is not provided in the second exemplary embodiment. This means that, in the second exemplary embodiment, the mechanical pre-charging switch 14 and the pre-charging resistor 13 are omitted.

In the second exemplary embodiment, the load-shedding circuit comprising the semiconductor switch 11 and the mechanical load-shedding switch 15 undertakes the task of the pre-charging circuit. For this purpose, the control for the load-shedding circuit, especially for the semiconductor switch 11, is adapted in the control unit. In doing so, advantageously, use is made of the fact that the semiconductor switch 11 is able to switch at high frequency and thus undertake the function of the resistor 13. At the instant at which the battery disconnect switch 4 is switched on, the load-shedding circuit is therefore used to limit the flowing current until the intermediate circuit is adequately pre-charged. For this purpose, the mechanical load-shedding switch 15 is switched on and the semiconductor switch 11 is switched on and off at a high frequency, for example a frequency of 5 kHz. When the intermediate circuit is adequately pre-charged, the battery disconnect switch 4 is closed, the semiconductor switch 11 is switched off and the mechanical load-shedding switch 15 opened once more. In the second exemplary embodiment, advantageously, a pre-charging circuit is therefore also realized simultaneously with the load-shedding circuit.

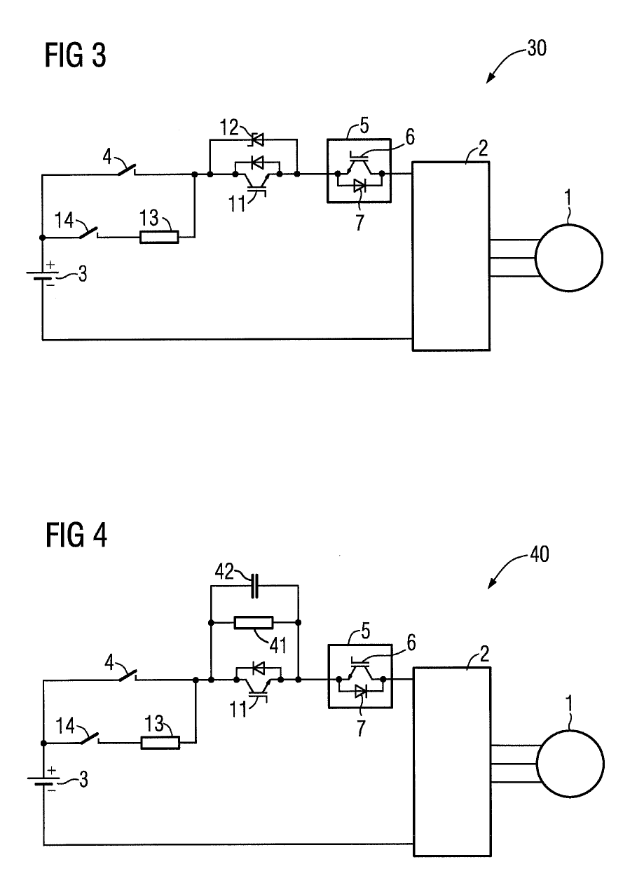

FIG. 3 shows a structure 30 according to a third exemplary embodiment. The elements electric motor 1, converter 2, battery 3 and battery disconnect switch 4 and the overvoltage protection 5 for the battery 3 are realized and arranged in a similar manner to the first and second exemplary embodiment. In the third exemplary embodiment, the load-shedding circuit is made up of the IGBT 11 and the suppressor diode 12 provided in parallel with the IGBT 11. In the third exemplary embodiment, the load-shedding circuit is provided in series with the battery disconnect switch 4 between this and the overvoltage protection 5.

Furthermore, a pre-charging circuit similar to that of the first exemplary embodiment is provided in the third exemplary embodiment. The pre-charging circuit includes a mechanical pre-charging switch 14 in series with a pre-charging resistor 13. Both elements are arranged in parallel with the battery disconnect switch 4. The function of the pre-charging circuit is similar to that in the first exemplary embodiment.

In the third exemplary embodiment, in order to switch off the current, the semiconductor switch 11 is switched off first. As already described, overvoltages which occur in doing so are limited by the suppressor diode 12. As in the first or second exemplary embodiment, the switching-off of the current is therefore shifted from the battery disconnect switch 4 to the semiconductor switch 11. When the semiconductor switch 11 has been switched off, the battery disconnect switch 4 can be opened in a current-free state.

In the third exemplary embodiment, the semiconductor switch 11 is always in the circuit of battery 3 and converter 2. In other words, it always carries the current which flows via the battery disconnect switch 4. As is known, semiconductor switches 11 have a higher electrical resistance than mechanical switches 4, 14, 15. Higher electrical losses therefore occur in the circuit according to the third exemplary embodiment than in the circuits according to the first and second exemplary embodiment. In return, the circuit and control complexity is reduced, as, in contrast to the three mechanical switches of the first exemplary embodiment, only two mechanical switches have to be provided in the third exemplary embodiment.

A fourth exemplary embodiment according to FIG. 4 shows how the overvoltage protection for the semiconductor switch 11 can be constructed as an alternative to the use of the suppressor diode 12. According to FIG. 4, a circuit including a resistor 41 arranged in parallel with the semiconductor switch 11 and a capacitor 42 arranged in parallel with both above-mentioned elements is provided in parallel with the semiconductor switch 11. In a further alternative construction, the options used for the overvoltage protection, that is to say suppressor diode 12 and RC circuit, can also be used in combination with one another.

A further simplification of the construction and therefore also of the control complexity results when a circuit according to the fifth exemplary embodiment, shown in FIG. 5, is used. In the fifth exemplary embodiment, the elements electric motor 1, converter 2, battery 3 and battery disconnect switch 4 and the overvoltage protection 5 for the battery 3 are again realized and arranged in a similar manner to the first and second exemplary embodiment.

In addition to the elements mentioned, only the load-shedding circuit including the semiconductor switch 11 and its overvoltage protection, in this case formed by a suppressor diode 12, is provided in the fifth exemplary embodiment. As in the third and fourth exemplary embodiments, the semiconductor switch 11 is arranged in series with the battery disconnect switch 4 between this and the overvoltage protection 5 for the battery 3.

In the fifth exemplary embodiment, as well as the switch load shedding for the battery disconnect switch 4, the load-shedding circuit again undertakes the function of the pre-charging circuit. The switch load-shedding function for the battery disconnect switch 4 works in a similar manner to the third and fourth exemplary embodiment. Once again, the switch-off operation is carried out by the semiconductor switch 11 and the battery disconnect switch 4 is switched off in the current-free state.

The semiconductor switch 11 is again used as a current-limiting element for the pre-charging function. This takes place in a similar manner to the second exemplary embodiment by an adequately high-frequency switching on and off of the semiconductor switch 11. In the fifth exemplary embodiment, the battery disconnect switch 4 is therefore also used for the task of pre-charging, which, in the second exemplary embodiment, was still undertaken by the mechanical load-shedding switch 15.

A single mechanical switch, namely the battery disconnect switch 4, which would be present in any case, is thus provided in the fifth exemplary embodiment. However, both the switch load shedding for the battery disconnect switch 4 and the pre-charging can be carried out in the fifth exemplary embodiment.

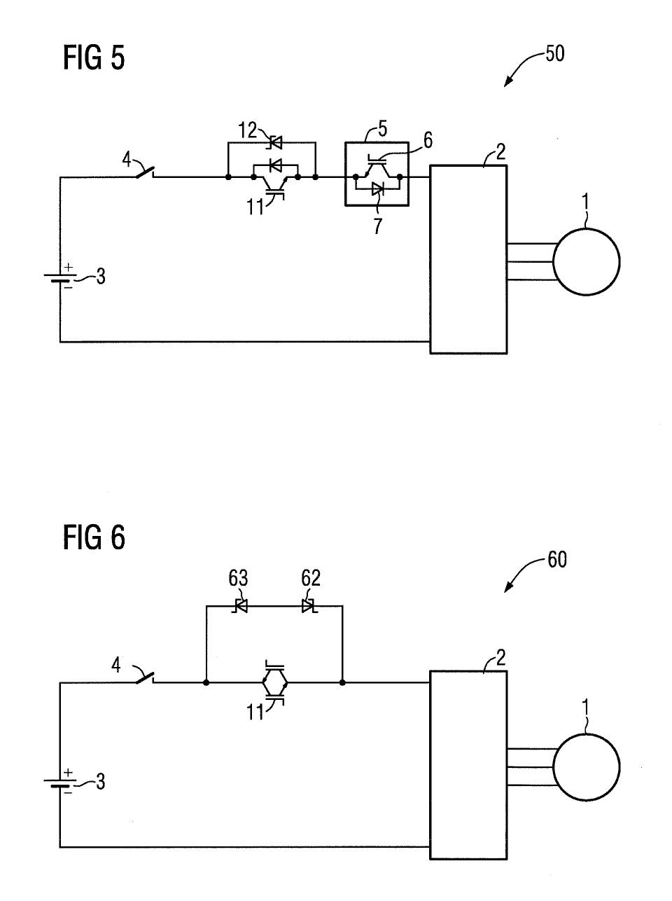

FIG. 6 shows a final, sixth exemplary embodiment. In the sixth exemplary embodiment, the elements electric motor 1, converter 2, battery 3 and battery disconnect switch 4 are again realized and arranged in a similar manner to the first and second exemplary embodiment.

However, in the sixth exemplary embodiment, the overvoltage protection 5 for the battery 3 and the load-shedding circuit are combined in a single circuit. For this purpose, in the sixth exemplary embodiment, a so-called reverse blocking IGBT 61 is provided in series with the battery disconnect switch 4. Overvoltage protection is provided for the reverse blocking IGBT 61 in parallel thereto. In the sixth exemplary embodiment, this includes two suppressor diodes 62, 63 connected in anti-series.

As already described for the fifth exemplary embodiment, the reverse blocking IGBT 61 undertakes the switch load shedding for the battery disconnect switch 4 in that, in order to switch off the current, the reverse blocking IGBT 61 is switched off first to then enable the battery disconnect switch 4 to be switched off in the current-free state. The reverse blocking IGBT 61 also undertakes the function of the pre-charging circuit, as the reverse blocking IGBT 61 can also be switched at high frequency to effect a current limitation. Finally, the reverse blocking IGBT 61 also undertakes the function of the overvoltage protection 5 for the battery 3. For this purpose, it is expedient that the reverse blocking IGBT 61 is switched on to enable current to flow from the battery 3 to the converter 2, but that it can be switched off at any time in order to block possible overvoltages from the direction of the electric motor 1. It is also expedient for this purpose to provide permanent function monitoring for the reverse blocking IGBT 61, as is also already the case for the overvoltage protection 5 from the first to fifth exemplary embodiment.

It is understood that certain components of the circuits shown here may have to be provided multiple times in an electrically operated vehicle. For example, when using a plurality of electric motors 1, it is expedient to provide a converter 2 for each of the electric motors 1. Likewise, a plurality of batteries 3 can be provided in the vehicle. The number of other components shown in the figures is simply to be matched to the number of electric motors 1, converters 2 or batteries 3.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d1865 (Fed. Cir. 2004).

1-13. (canceled)

14. A switch load-shedding device comprising:
a disconnect switch for galvanically isolating an electrical connection; and
a semiconductor switch through which current is allowed to flow before the disconnect switch is switched off, to reduce a voltage buildup across the disconnect switch when the disconnect switch is being switched off.

15. The device as claimed in claim 14, wherein the current which is to be switched off flows via the semiconductor switch at least after the disconnect switch has been switched off.

16. The device as claimed in claim 14, wherein a series circuit comprising a mechanical load-shedding switch and the semiconductor switch is arranged in parallel with the disconnect switch.

17. The device as claimed in claim 16, wherein
first the mechanical load-shedding switch and then the semiconductor switch are switched to a conducting state and then the disconnect switch is switched off in order to isolate the electrical connection.

18. The device as claimed in claim 14, wherein
the current which is to be switched off flows via the semiconductor switch before the disconnect switch has been switched off, and
the current which is to be switched off flows via the semiconductor switch after the disconnect switch has been switched off.

19. The device as claimed in claim 14, wherein the semiconductor switch is arranged in series with the disconnect switch.

20. The device as claimed in claim 19, wherein first the semiconductor switch is switched to a non-conducting state and then the disconnect switch is switched off in order to isolate the electrical connection.

21. The device as claimed in claim 14, further comprising an overvoltage protection device for the semiconductor switch, provided in parallel with the semiconductor switch.

22. The device according to claim 14, further comprising a pre-charging circuit provided in parallel with the disconnect switch, the pre-charging circuit comprising a mechanical pre-charging switch in series with a pre-charging resistor to limit the current.

23. The device as claimed in claim 14, wherein the semiconductor switch is pulsed on and off to function as a current limiter.

24. The device as claimed in claim 14, further comprising an overvoltage protection device in series with the disconnect switch.

25. The device as claimed in claim 14, further comprising:
a first overvoltage protection device provided in parallel with the semiconductor switch, for protection of the semiconductor switch; and
a second overvoltage protection device provided in series with the disconnect switch.

26. The device as claimed in one of claim 14, wherein
the semiconductor switch is arranged in series with the disconnect switch,
a first overvoltage protection device is provided in parallel with the semiconductor switch, for protection of the semiconductor switch, and
in addition to reducing a voltage buildup across the disconnect switch, the semiconductor switch functions as a second overvoltage protection device for protection of a battery.

27. The device as claimed in claim 14, wherein the disconnect switch galvanically isolates a battery from an intermediate circuit of a converter.

28. A drive system of an electrically operated vehicle having a battery, an electric motor and a converter provided between the battery and the electric motor, the converter having an intermediate circuit, the drive system comprising:
a disconnect switch for galvanically isolating the battery from the intermediate circuit of the converter, at an intermediate circuit voltage greater than 24 V; and
a load-shedding device comprising a semiconductor switch through which current is allowed to flow before the disconnect switch is switched off, to reduce a voltage buildup across the disconnect switch when the disconnect switch is being switched off.
